(19) United States
(12) Patent Application Publication
(10) Pub. No.: US 2015/0221989 A1
(43) Pub. Date: Aug. 6, 2015

(54) POSITIVE ELECTRODE ACTIVE MATERIAL FOR ALKALINE STORAGE BATTERIES, POSITIVE ELECTRODE FOR ALKALINE STORAGE BATTERIES AND ALKALINE STORAGE BATTERY INCLUDING THE SAME, AND NICKEL-METAL HYDRIDE STORAGE BATTERY

(71) Applicant: Panasonic Intellectual Property Managemant Co., Ltd., Osaka-shi, Osaka (JP)

(72) Inventors: Kiyoshi Hayashi, Osaka (JP); Yasushi Nakamura, Osaka (JP); Yasuhiro Nitta, Osaka (JP)

(21) Appl. No.: 14/423,007

(22) PCT Filed: Aug. 29, 2013
(86) PCT No.: PCT/JP2013/005107

§ 371 Date: Feb. 20, 2015

(30) Foreign Application Priority Data
Sep. 26, 2012 (JP) 2012-212354

(51) Int. Cl. H01M 10/30; H01M 4/62; H01M 10/26; H01M 4/52; H01M 4/32; H01M 4/24

(52) U.S. Cl. CPC H01M 10/30; H01M 4/32; H01M 4/242; H01M 10/26; H01M 4/52; H01M 4/624; H01M 2004/028

(57) ABSTRACT

Provided is a positive electrode active material for alkaline storage batteries that enables to achieve a high charging efficiency in a wide temperature range including high temperatures, and suppress self-discharge. The positive electrode active material for alkaline storage batteries includes a nickel oxide. In a powder X-ray 2θ/θ diffraction pattern using CuKα radiation of the nickel oxide, the ratio I₀₀₁/I₁₀₁ of a peak intensity I₀₀₁ of (001) plane to a peak intensity I₁₀₁ of (101) plane is 2 or more, and the ratio FWHM₀₀₁/FWHM₁₀₁ of a full width at half maximum FWHM₀₀₁ of (001) plane to a full width at half maximum FWHM₁₀₁ of (101) plane is 0.6 or less.

### TECHNICAL FIELD

The present invention relates to a positive electrode active material for alkaline storage batteries, a positive electrode for alkaline storage batteries and an alkaline storage battery including the same, and a nickel-metal hydride storage battery, specifically to an improvement of a positive electrode active material for alkaline storage batteries.

### BACKGROUND ART

Alkaline storage batteries such as nickel-cadmium storage batteries and nickel-metal hydride storage batteries have high capacity, and therefore have been utilized for various applications. Particularly in recent years, alkaline storage batteries are supposed to be used as main power source for hybrid cars and electronic equipment such as portable devices, and as backup power source, for example, as an uninterruptive power supply. For such applications, the batteries are required to be charged quickly, or charged at a wide range of temperatures including high temperatures. Therefore, high charging efficiency needs to be achieved when charging at a wide range of temperatures.

Alkaline storage batteries typically include a nickel oxide, including nickel oxyhydroxide and nickel hydroxide, as a positive electrode active material. During charge, nickel hydroxide is converted into nickel oxyhydroxide; during discharge, nickel oxyhydroxide is converted into nickel hydroxide.

Negative electrode: MH+OH⁻ [symbol] M+H₂O+e⁻

Positive electrode: NiOOH+H₂O+e⁻ [symbol] Ni(OH)₂+OH⁻

Whole reaction: NiOOH+MH [symbol] Ni(OH)₂+M [Chem. 1]

(In the formulas, M represents a hydrogen storage alloy)

In view of increasing the capacity and output of alkaline storage batteries, one proposal suggests using a positive electrode in which a nickel oxide as above is densely packed.

In view of improving the discharge capacity, cycle life and rate characteristics, Patent Literature 1 discloses using a nickel hydroxide powder in an electrode for alkaline secondary batteries. The nickel hydroxide powder exhibits a powder X-ray 2θ/θ diffraction pattern using CuKα radiation in which a half width r (2θ) of a peak of (001) plane is 0.5 to 1.2°, and the half width r and an intensity p of the above peak satisfy 1000≦p/r≦2000.

To obtain a high capacity in a wider temperature range and improve the cycle life, Patent Literature 2 discloses a positive electrode for alkaline storage batteries which is mainly composed of a nickel hydroxide. The nickel hydroxide has an X-ray diffraction peak of (001) plane having a half width at 2θ being 0.65 degrees or less, and a value of peak intensity/half width of (001) plane being 10,000 or more.

### CITATION LIST

### Patent Literature

### [PTL 1] Japanese Laid-Open Patent Publication No. 2001-176505

[PTL 2] Japanese Laid-Open Patent Publication No. Hei 10-270042

### SUMMARY OF INVENTION

### Technical Problem

With the increased expansion of their applications, alkaline storage batteries are expected to have a high charging efficiency in a wide temperature range including high temperatures. In alkaline storage batteries, however, when charged at high temperatures, oxygen tends to be produced at the positive electrode, and the produced oxygen impedes the conversion of the nickel hydroxide to nickel oxyhydroxide. In short, at high temperatures, the charge reaction tends to be inhibited, decreasing the charging efficiency. Moreover, at high temperatures, the battery capacity tends to be reduced due to self-discharge.

### Solution to Problem

An object of the present invention is to provide a positive electrode active material for alkaline storage batteries that enables to achieve a high charging efficiency in a wide temperature range including high temperatures and to suppress self-discharge.

One aspect of the present invention relates to a positive electrode active material for alkaline storage batteries. The positive electrode active material includes a nickel oxide. The nickel oxide has a ratio I₀₀₁/I₁₀₁ of a peak intensity I₀₀₁ of (001) plane to a peak intensity I₁₀₁ of (101) plane being 2 or more, and a ratio FWHM₀₀₁/FWHM₁₀₁ of a full width at half maximum FWHM₀₀₁ of (001) plane to a full width at half maximum FWHM₁₀₁ of (101) plane being 0.6 or less, in a powder X-ray 2θ/θ diffraction pattern using CuKα radiation.

Another aspect of the present invention relates to a positive electrode for alkaline storage batteries. The positive electrode includes an electrically conductive support, and the aforementioned positive electrode active material for alkaline storage batteries adhering to the support.

Yet another aspect of the present invention relates to an alkaline storage battery including a positive electrode, a negative electrode, a separator interposed between the positive electrode and the negative electrode, and an alkaline electrolyte. The positive electrode is the aforementioned positive electrode for alkaline storage batteries.

Still another aspect of the present invention relates to a nickel-metal hydride storage battery including a positive electrode, a negative electrode including a hydrogen storage alloy powder capable of electrochemically absorbing and releasing hydrogen, a separator interposed between the positive electrode and the negative electrode, and an alkaline electrolyte. The positive electrode includes an electrically conductive support, and a mixture of a positive electrode active material and a metal compound, the mixture adhering to the support. The positive electrode active material includes a particle including a nickel oxide, and an electrically conductive layer formed on a surface of the particle and including a cobalt oxide. The nickel oxide includes cobalt and zinc that are incorporated in a crystal structure of the nickel oxide. The nickel oxide has a ratio I₀₀₁/I₁₀₁ of a peak intensity I₀₀₁ of (001) plane to a peak intensity I₁₀₁ of (101) plane being 2 to 2.2, and a ratio FWHM₀₀₁/FWHM₁₀₁ of a full width at half maximum FWHM₀₀₁ of (001) plane to a full width at half maximum FWHM₁₀₁ of (101) plane being 0.55 to 0.6, in a powder X-ray 2θ/θ diffraction pattern using CuKα radiation. The metal compound includes at least one metal element selected from the group consisting of calcium, ytterbium, titanium, and zinc. The alkaline electrolyte is an aqueous alkaline solution containing at least sodium hydroxide at a concentration of 4 to 10 mol/dm³.

### Advantageous Effects of Invention

In the present invention, the crystal structure of a nickel oxide to be used as a positive electrode active material in an alkaline storage battery is controlled so as to be advantageous for improving the proton diffusivity. Therefore, a high charging efficiency can be achieved in a wide temperature range including high temperatures. This makes it possible to use the alkaline storage battery in a wide temperature range. Moreover, the self-discharge of the battery can be suppressed even after storage for a long period.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 An X-ray diffraction spectrum of a nickel oxide D3 of Example 4.

FIG. 2 A schematic longitudinal cross-sectional view of an alkaline storage battery according to one embodiment of the present invention.

### DESCRIPTION OF EMBODIMENTS

A nickel oxide exhibits high proton diffusivity when the crystallinity of (001) plane is high in its powder X-ray 2θ/θ diffraction pattern using CuKα radiation, that is, the peak intensity of (001) plane in its X-ray diffraction spectrum is high. Using such a nickel hydroxide as a positive electrode active material in an alkaline storage battery can suppress polarization of the battery, and thus can improve the charging efficiency even at high temperatures and achieve a high positive electrode utilization rate (positive electrode active material utilization rate). However, when the crystallinity of (001) plane is increased too high, the crystallinity of (101) plane also becomes high. This slows the proton diffusion, resulting in a low positive electrode utilization rate.

Therefore, the present invention controls a peak intensity ratio and a full width at half maximum ratio between those of (001) plane and (101) plane in a powder X-ray 2θ/θ diffraction pattern using CuKα radiation of the nickel oxide. Specifically, the aforementioned nickel oxide has a ratio I₀₀₁/I₁₀₁ of a peak intensity I₀₀₁ of (001) plane to a peak intensity I₁₀₁ of (101) plane being 2 or more, and a ratio FWHM₀₀₁/FWHM₁₀₁ of a full width at half maximum FWHM₀₀₁ of (001) plane to a full width at half maximum FWHM₁₀₁ of (101) plane being 0.6 or less, in its powder X-ray 2θ/θ diffraction pattern using CuKα radiation.

As the peak intensity I₀₀₁ of (001) plane of the nickel oxide increases, that is, as the crystallinity along (001) plane increases, the crystals become more uniform, and the electric conductivity improves. Presumably, this improves the charging efficiency. In general, as the crystallinity of a nickel oxide increases, the profile of crystallinity thereof becomes high at all planes. Therefore, when the crystallinity along (001) plane is increased, the crystallinity along (101) plane is also increased, accordingly. However, when the crystallinity along (101) plane becomes too high, the reaction between proton and nickel oxyhydroxide is inhibited. Presumably, this lowers the positive electrode utilization rate. In other words, even though the peak intensities of (001) and (101) planes are both increased, it is considered difficult to improve the electrical conduction efficiency. Increasing the crystallinity of one of those planes only is also considered difficult.

The present inventors have found that the peak intensity and the full width at half maximum of (001) plane and those of (101) plane vary in a correlated manner, and the peak intensity and the full width at half maximum of each plane both influence the charging efficiency. In short, the present invention adjusts the balance between the crystallinity profiles of (001) plane and (101) plane, thereby to improve the charging efficiency and suppress the self-discharge.

Specifically, the present inventors have found that by controlling the peak intensity ratio I₀₀₁/I₁₀₁ and the full width at half maximum ratio FWHM₀₀₁/FWHM₁₀₁ at (001) plane and (101) plane, even when charging at high temperatures, the charging efficiency can be improved more than ever before.

Moreover, by controlling the peak intensity ratio I₀₀₁/I₁₀₁ and the full width at half maximum ratio FWHM₀₀₁/FWHM₁₀₁, a high charging efficiency can be achieved at normal charging temperatures. Therefore, using the positive electrode active material of the present invention in an alkaline storage battery can provide a high charging efficiency in a wide temperature range, and enables the alkaline storage battery to be used at a wide range of temperatures. Furthermore, due to the high charging efficiency, i.e., the high positive electrode utilization rate, a high battery capacity can be achieved.

Typically, alkaline storage batteries show high self-discharge. Therefore, when the battery is left unused for a long period, sufficient power may not be supplied to the device. For example, in such an application as hybrid cars, high-rate discharge becomes difficult, and the engine may not be started. The improvement in self-discharge characteristics is also supposed to be necessary.

The present inventors have further found that by controlling the peak intensity ratio I₀₀₁/I₁₀₁ and the full width at half maximum ratio FWHM₀₀₁/FWHM₁₀₁, the battery capacity can be kept high and the self-discharge can be significantly suppressed even after the battery is stored for a long period.

In short, in the present invention, the peak intensity ratio I₀₀₁/I₁₀₁ and the full width at half maximum ratio FWHM₀₀₁/FWHM₁₀₁ are controlled as above, whereby a high charging efficiency can be obtained in a wide temperature range, and the self-discharge can be suppressed.

The peak intensity ratio I₀₀₁/I₁₀₁ is 2 or more, and preferably 2.05 or more. When the peak intensity ratio I₀₀₁/I₁₀₁ is less than 2, the charging efficiency decreases. Particularly when charged at a high temperature about 60° C., the decrease in charging efficiency is notable. When the peak intensity ratio I₀₀₁/I₁₀₁ is less than 2, the self-discharge also tends to be notable. The peak intensity ratio I₀₀₁/I₁₀₁ is, for example, 2.5 or less, preferably 2.3 or less, more preferably less than 2.3, and still more preferably 2.2 or less. These lower limits and upper limits can be combined in any combination. The peak intensity ratio I₀₀₁/I₁₀₁ is, for example, 2 to 2.3, or 2 to 2.2. When the peak intensity ratio I₀₀₁/I₁₀₁ is within such a range, a high charging efficiency can be obtained, and the self-discharge can be more effectively suppressed.

The full width at half maximum ratio FWHM₀₀₁/FWHM₁₀₁ is 0.6 or less, and preferably 0.58 or less. When the full width at half maximum ratio FWHM₀₀₁/FWHM₁₀₁ exceeds 0.6, the charging efficiency decreases, and in particular, the decrease in charging efficiency when charged at a high temperature about 60° C. is notable. When the full width at half maximum ratio FWHM₀₀₁/FWHM₁₀₁ exceeds 0.6, the self-discharge also tends to be severe. The full width at half maximum ratio FWHM₀₀₁/FWHM₁₀₁ is, for example, 0.45 or more, preferably 0.5 or more, and more preferably 0.55 or more. These upper limits and lower limits can be combined in any combination. The full width at half maximum ratio FWHM₀₀₁/FWHM₁₀₁ is, for example, 0.5 to 0.6, or 0.55 to 0.6. When the full width at half maximum ratio is within such a range, a high charging efficiency can be achieved, and the self-discharge can be more effectively suppressed.

The nickel oxide included in the positive electrode active material for alkaline storage batteries of the present invention mainly includes nickel oxyhydroxide and/or nickel hydroxide.

The nickel oxide can be obtained by mixing an aqueous solution of an inorganic acid salt of nickel and an aqueous solution of a metal hydroxide. Mixing of these aqueous solutions causes particles including a nickel oxide to precipitate in the mixed solution. To stabilize the metal ion, such as nickel ion, a complexing agent may be added to the mixed solution or the aqueous solution of an inorganic acid salt of nickel. The complexing agent may be added in the form of aqueous solution.

The peak intensity ratio I₀₀₁/I₁₀₁ and the full width at half maximum ratio FWHM₀₀₁/FWHM₁₀₁ can be controlled within the range as above by adjusting the conditions for mixing the aqueous solution of an inorganic acid salt of nickel and the aqueous solution of a metal hydroxide, for example, the concentrations of the inorganic acid salt of nickel and the metal hydroxide, the concentration of the aqueous solution containing the complexing agent, the mixing ratio of these components, the supply rates of the aqueous solution of an inorganic acid salt of nickel and the aqueous solution of a metal hydroxide (mixing speed), and the temperature of the mixed solution.

The inorganic acid salt can be, for example, an inorganic strong acid salt, and is preferably sulfate.

The concentration of the inorganic acid salt of nickel in the aqueous solution is, for example, 1 to 5 mol/dm³, preferably 1.5 to 4 mol/dm³, and more preferably 2 to 3 mol/dm³.

The metal hydroxide can be, for example, an alkali metal hydroxide, such as sodium hydroxide and potassium hydroxide.

The concentration of the metal hydroxide in the aqueous solution is, for example, 2 to 12 mol/dm³, preferably 3 to 10 mol/dm³, and more preferably 4 to 8 mol/dm³.

The metal hydroxide is used in such a proportion that the stoichiometry ratio of the nickel of the inorganic acid salt to the hydroxide ion derived from the metal hydroxide is 1:2 (molar ratio). The molar amount of the hydroxide ion is preferably slightly in excess of twice the amount of the nickel of the inorganic acid salt. The amount of the hydroxide ion may be, for example, 2.1 mol or more, relative to 1 mol of the nickel of the inorganic acid salt. The upper limit thereof of the hydroxide ion is not particularly limited, and the amount may be 3 mol or less, or 2.5 mol or less, relative to 1 mol of the nickel of the inorganic acid salt.

The complexing agent may be a base, and preferably an inorganic base such as ammonia.

The complexing agent is used in such a proportion of, for example, 1.8 to 3 mol (e.g., 2 to 3 mol), relative to 1 mol of the nickel of the inorganic acid salt.

The temperature of the mixed solution is, for example, 30 to 65° C., preferably 40 to 50° C., and more preferably 45 to 55° C.

The average diameter of particles including the nickel oxide thus obtained is, for example, 3 to 25 μm.

The nickel oxide may include a metal element (first metal element) incorporated in the crystal structure of the nickel oxide. Specifically, the nickel oxide may be a solid solution including a first metal element.

Examples of the first metal element include alkaline earth metal elements, such as magnesium and calcium, and transition metal elements (e.g., Periodic Table Group 9 elements, such as cobalt; Periodic Table Group 12 elements, such as zinc and cadmium). These first metal elements may be used singly or in combination of two or more. Preferred among these first metal elements is at least one selected from the group consisting of magnesium, cobalt, cadmium, and zinc. The first metal element preferably includes cobalt and at least one selected from the group consisting of magnesium, cadmium, and zinc, and more preferably, cobalt and zinc.

Including such a first metal element in the nickel oxide can further increase the charging efficiency, and can more effectively improve the positive electrode utilization rate. In particular, even at high temperatures, a high charging efficiency can be achieved. Moreover, the self-discharge during storage can be more effectively suppressed.

The amount of first metal element is, for example, 0.1 to 10 parts by mass, preferably, 0.5 to 5 parts by mass, and more preferably 0.7 to 3 parts by mass, relative to 100 parts by mass of the nickel contained in the nickel oxide. With such a range, the effect due to combining the nickel oxide whose crystallinity is controlled, with the first metal element can be easily obtained.

The first metal element can be incorporated into the crystal structure of the nickel oxide by allowing the first metal element to exist when mixing an aqueous solution of an inorganic acid salt of nickel and an aqueous solution of a metal hydroxide. Specifically, an aqueous solution of an inorganic acid salt of nickel is added with an inorganic acid salt of the first metal element, and the resultant solution is mixed with an aqueous solution of a metal hydroxide. A nickel oxide including the first metal element can be thus obtained.

On the surface of particles including the nickel oxide thus obtained, an electrically conductive layer may be further formed.

The conductive layer preferably includes a metal oxide such as a cobalt oxide, as a conductive agent. Examples of the metal oxide include oxides such as cobalt oxide, and oxyhydroxides such as cobalt oxyhydroxide.

The amount of conductive agent is, for example, 2 to 10 parts by mass, preferably 3 to 7 parts by mass, and more preferably 4 to 5 parts by mass, relative to 100 parts by mass of nickel oxide.

The conductive layer can be formed by any known method, depending on the type of the conductive agent.

For example, (a) when forming a conductive layer including a metal oxide such as a cobalt oxide, a metal hydroxide such as cobalt hydroxide is allowed to adhere to the surfaces of particles including the nickel oxide, and then (b) the metal hydroxide is converted into a metal oxide such as γ-cobalt oxyhydroxide by heat treatment in the presence of an alkali metal hydroxide.

In the above (a), the metal hydroxide such as cobalt hydroxide can be allowed to adhere to the particle surfaces by, for example, dispersing particles including the nickel oxide in an aqueous solution including a metal inorganic acid salt, to which a metal hydroxide such as cobalt hydroxide is then added. The inorganic acid salt can be, for example, inorganic strong acid salt such as sulfate. The complexing agent as exemplified above such as ammonia may be added to the aqueous solution including a metal inorganic acid salt.

In the above (b), the particles including the nickel oxide and having a metal hydroxide such as cobalt hydroxide adhering to their surfaces are heated in the presence of an alkali metal hydroxide such as sodium hydroxide and potassium hydroxide. Thereby the metal hydroxide such as cobalt hydroxide adhering to the particle surfaces is converted into an oxide such as γ-cobalt oxyhydroxide, forming a highly electrically conductive layer on the particle surfaces.

### (Alkaline Storage Battery)

An alkaline storage battery includes a positive electrode, a negative electrode, a separator interposed between the positive electrode and the negative electrode, and an alkaline electrolyte.

The positive electrode includes the aforementioned positive electrode active material. Specifically, the positive electrode includes an electrically conductive support, and the aforementioned positive electrode active material adhering to the support.

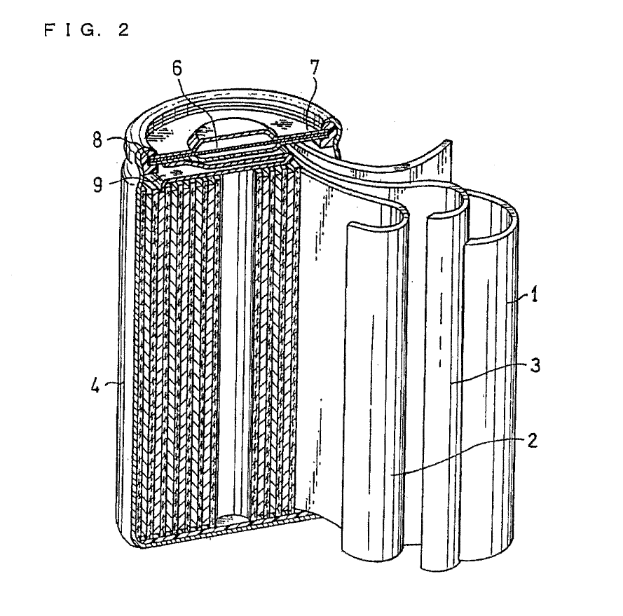

The alkaline storage battery will be described below with reference to FIG. 2. FIG. 2 is a schematic longitudinal cross-sectional view of an alkaline storage battery according to one embodiment of present invention. The alkaline storage battery includes a bottom-closed cylindrical battery case 4 serving as a negative terminal, an electrode group housed in the battery case 4, and an alkaline electrolyte (not shown). The electrode group includes a negative electrode 1, a positive electrode 2, and a separator 3 interposed therebetween, which are spirally wound together. A sealing plate 7 provided with a safety valve 6 is placed at the opening of the battery case 4, with an insulating gasket 8 interposed therebetween. The opening end of the battery case 4 is crimped inwardly, and thereby the alkaline storage battery is sealed. The sealing plate 7, which serves as a positive terminal, is electrically connected to the positive electrode 2 via a positive electrode current collector 9.

Such an alkaline storage battery can be obtained by placing an electrode group in the battery case 4, injecting an alkaline electrolyte, disposing the sealing plate 7 at the opening of the battery case 4 with the insulating gasket 8 interposed therebetween, and crimp-sealing the opening end of the battery case 4. The negative electrode 1 of the electrode group is, at its outermost periphery, contacted with the battery case 4, and electrically connected thereto. The positive electrode 2 of the electrode group and the sealing plate 7 are electrically connected to each other via the positive electrode current collector 9.

Examples of the alkaline storage battery include nickel-metal hydride storage batteries, nickel-cadmium storage batteries, and nickel-zinc storage batteries. According to the present invention, the self-discharge can be significantly suppressed by using the aforementioned positive electrode active material. Therefore, even in nickel-metal hydride batteries which show high self-discharge, the self-discharge can be effectively suppressed.

The alkaline storage battery will be more specifically described below.

(Positive Electrode)

The conductive support included in the positive electrode can be any conductive support used in the positive electrode for alkaline storage batteries. The conductive support may be a three-dimensional porous material, or a flat plate or sheet.

The positive electrode can be obtained by allowing a positive electrode paste including at least a positive electrode active material to adhere to the support. Depending on the shape etc. of the support, the positive electrode paste may apply onto the support, or packed into the pores of the support.

The positive electrode paste can be prepared by mixing a positive electrode active material and a dispersion medium. The positive electrode can be usually formed by applying the positive electrode paste onto the support, and drying the paste to remove the dispersion medium, followed by pressing. Examples of the dispersion medium include water, an organic medium, or a mixed medium thereof.

Any known conductive agent, binder, and the like may be added, if necessary, to the positive electrode paste.

A positive electrode paste including a metal compound in addition to the positive electrode active material may be used to form a positive electrode. The positive electrode includes a mixture adhering to the support and including the positive electrode active material for alkaline storage batteries and the metal compound.

When the positive electrode includes such a metal compound, the charging efficiency can be further increased, and the positive electrode utilization rate can be more effectively improved. In particular, the charging efficiency at high temperatures can be significantly improved. Moreover, the self-discharge during storage can be remarkably suppressed.

Such a metal compound differs in type from the positive electrode active material, and contains, for example, at least one metal element (second metal element) selected from the group consisting of alkali earth metals (e.g., berylium, calcium, barium), Periodic Table Group 3 metals (e.g., scandium, yttrium, lanthanoids), Group 4 metals (e.g., titanium, zirconium), Group 5 metals (e.g., vanadium, niobium), Group 12 metals (e.g., zinc), Group 13 metals (e.g., indium), and Group 15 metals (e.g., antimony). Examples of lanthanoids include erbium, thulium, ytterbium, and lutetium.

Preferred among these second metal elements is at least one selected from the group consisting of alkali earth metals, Group 3 metals (e.g., lanthanoids), Group 4 metals, and Group 12 metals. Particularly preferred among them is at least one selected from the group consisting of calcium, ytterbium, titanium, and zinc. The second metal element may include one of these metals, or two to four metals belonging to different groups in the periodic table. For example, the second metal element may include ytterbium, titanium, and zinc all together.

Examples of the metal compound including the second metal element include oxides, hydroxides, fluorides, and inorganic acid salts (e.g., sulfate). These metal compounds may be used singly or in combination of two or more. Preferred among them are, for example, oxides, hydroxides, and fluorides. The oxides and hydroxides may be peroxides.

Specific examples of the metal compound containing the second metal element include: oxides, such as BeO, Sc₂O₃, Y₂O₃, Er₂O₃, Tm₂O₃, Yb₂O₃, Lu₂O₃, TiO₂, ZrO₂, V₂O₅, Nb₂O₅, ZnO, In₂O₃, and Sb₂O₃; and hydroxides, such as Ca(OH)₂ and Ba(OH)₂; and fluorides, such as CaF₂.

The amount of metal compound is, for example, 0.1 to 5 parts by mass, preferably 0.5 to 3 parts by mass, and more preferably 0.7 to 2 parts by mass, relative to 100 parts by mass of the nickel oxide serving as the positive electrode active material. When the amount of metal compound is within such a range, the effect due to combining the nickel oxide whose crystallinity is controlled, with the metal compound containing the second metal element can be easily obtained.

When using two or more metal compounds, it is preferable to adjust the amount of each metal compound so that the total amount thereof falls within the above range. Two or more metal compounds may be used in such a proportion that they are contained in substantially equal amounts. For example, an ytterbium-containing compound, a titanium-containing compound, and a zinc-containing compound may be used in a mass ratio, for example, 1:(0.8 to 1.2):(0.8 to 1.2).

(Negative Electrode)

Any negative electrode can be used depending on the type of the alkaline storage battery. In a nickel-metal hydride storage battery, for example, a negative electrode including a hydrogen storage alloy powder capable of electrochemically absorbing and releasing hydrogen, as a negative electrode active material, can be used. In a nickel-cadmium storage battery, for example, a negative electrode including a cadmium compound, such as cadmium hydroxide, as a negative electrode active material can be used.

The negative electrode may include a core material and a negative electrode active material adhering to the core material. Such a negative electrode can be formed by allowing a negative electrode paste including at least a negative electrode active material to adhere to the core material. The negative electrode paste usually includes a dispersion medium, and may further include any known component used for negative electrodes, if necessary, for example, a conductive agent, a binder, and/or a thickener. The dispersion medium may be any known medium, for example, water, an organic medium, or a mixed medium thereof. The negative electrode can be formed by applying the negative electrode paste onto the core material, and drying the paste to remove the dispersion medium, followed by pressing.

(Alkaline Electrolyte)

The alkaline electrolyte can be, for example, an aqueous solution containing an alkaline solute. Examples of the alkaline solute include alkaline metal hydroxides such as lithium hydroxide, potassium hydroxide, and sodium hydroxide. These may be used singly or in combination of two or more.

The concentration of alkaline solute in the alkaline electrolyte is, for example, 2.5 to 13 mol/dm³, preferably 3 to 12 mol/dm, and more preferably 3.5 to 10.5 mol/dm³.

The alkaline electrolyte preferably includes at least sodium hydroxide. Sodium hydroxide may be used in combination with lithium hydroxide and/or potassium hydroxide. The alkaline electrolyte may include sodium hydroxide only, as the alkaline solute.

The concentration of sodium hydroxide in the alkaline electrolyte is, for example, 2.5 to 11.5 mol/dm³, preferably 3 to 11 mol/dm³, more preferably 3.5 to 10.5 mol/dm³, and particularly preferably 4 to 10 mol/dm³. When the concentration of sodium hydroxide is within such a range, the charging efficiency can be more effectively increased even when charging at high temperatures, and the self-discharge can be more effectively suppressed. Furthermore, while keeping the high charging efficiency, it is possible to suppress the drop in discharge average voltage and improve the cycle life.

(Others)

As for the separator, the battery case, and other component elements, those commonly used for alkaline storage batteries can be used.

### EXAMPLES

The present invention will now be specifically described with reference to Examples and Comparative Examples. The present invention however should not be construed as being limited to the following examples.

### Example 1

### (i) Production of Nickel Oxide

An aqueous solution containing nickel sulfate in a concentration of 2.5 mol/dm³, an aqueous solution containing sodium hydroxide in a concentration of 5.5 mol/dm³, and an aqueous solution containing ammonia in a concentration of 5.0 mol/dm³ were supplied in a mass ratio of 1:1:1 into a reactor vessel, each at a predetermined supply rate, and mixed, to allow a nickel oxide mainly containing nickel hydroxide to precipitate. The temperature of the mixed solution at this time was 50° C.

The precipitated nickel oxide was separated by filtration, and washed with an aqueous sodium hydroxide solution having a predetermined concentration, thereby to remove impurities such as sulfate ion. This was followed by washing with water and drying. Nickel oxide particles were thus obtained.

The nickel oxide particles were added to an aqueous cobalt sulfate solution (concentration: 2.5 mol/dm³) to give a mixture. The mixture, an aqueous ammonia solution (concentration: 5.0 mol/dm³), and an aqueous sodium hydroxide solution (concentration: 5.5 mol/dm³) were supplied into a reactor vessel, each at a predetermined supply rate, and mixed while stirred. In that way, cobalt hydroxide was deposited on the surface of the nickel oxide particles, to form a coating layer containing cobalt hydroxide.

The nickel oxide particles with the coating layer formed thereon was collected, and heated at 90 to 130° C. in the presence of an aqueous solution containing sodium hydroxide in high concentration (40 mass % or more), while air (oxygen) was supplied thereto. Thereby the cobalt hydroxide was converted into an electrically conductive cobalt oxide. A nickel oxide A1 comprising nickel oxide particles with a conductive layer of cobalt oxide formed thereon was obtained.

Nickel oxides A2 to A20 differing in crystallinity were produced in the same manner as the nickel oxide A1 was produced, except that the concentration and supply rate of each aqueous solution, the mixing ratio of aqueous solutions, and/or the temperature of the mixed solution were appropriately adjusted.

The nickel oxides A1 to A20 were substantially spherical particles, and the average particle diameter of each oxide was about 10 μm.

### (ii) Measurement of X-Ray Diffraction Spectra

Powder X-ray 2θ/θ diffraction spectra using CuKα radiation of the nickel oxides obtained in (i) above were measured with an X-ray diffractometer (X'PertPRO available from PANalytical B.V.), under the following conditions.

Lamp voltage: 45 kV

Lamp current: 40 mA

Slit: DS=0.5 deg, RS=0.1 mm

Target/Monochromator: Cu/C

Step width: 0.02 deg

Scanning rate: 100 sec/step

With respect to the (001) plane and the (101) plane in the X-ray 2θ/θ diffraction patterns, peak intensities I₀₀₁ and I₁₀₁, and full widths at half maximum FWHM₀₀₁ and FWHM₁₀₁ were determined. These values are shown in Table 1, along with a peak intensity ratio I₀₀₁/I₁₀₁ and a full width at half maximum ratio FWHM₀₀₁/FWHM₁₀₁ of each nickel oxide.

### (iii) Production of Positive Electrode

The nickel oxide A1 serving as a positive electrode active material was mixed with a predetermined amount of water, to prepare a positive electrode paste.

The resultant positive electrode paste was packed into a porous nickel foam (porosity: 95%, plane density: 300 g/cm²) serving as a core material, dried and pressed, and then, cut in a predetermined size (thickness: 0.5 mm, length: 110 mm, width: 35 mm), thereby to produce a positive electrode. The amount of the positive electrode paste to be packed and the degree of pressing were adjusted such that, given that the nickel oxide performs one-electron reaction during charge and discharge, the positive electrode had a theoretical capacity of 1000 mAh. At one end of the positive electrode along its longitudinal direction, the core material was exposed as a core material-exposed portion.

Positive electrodes were produced using the nickel oxides A2 to A20, in the same manner as produced using the nickel oxide A1.

### (iv) Production of Negative Electrode

First, 100 parts by mass of MmNi_{3.6}Co_{0.7}Mn_{0.4}Al_{0.3} serving as a hydrogen storage alloy, 0.15 parts by mass of carboxymethyl cellulose serving as a thickener, 0.3 parts by mass of carbon black serving as a conductive agent, and 0.7 parts by mass of styrene-butadiene copolymer serving as a binder were mixed together. Water was added to the resultant mixture and further mixed, to prepare a negative electrode paste.

The negative electrode paste was applied onto both faces of a nickel-plated iron punching metal (thickness: 30 μm) as a core material, to form an applied film on each face. The applied films were dried and pressed together with the core material, and cut in a predetermined size (thickness: 0.3 mm, length: 134 mm, width: 36 mm), thereby to produce a hydrogen storage alloy negative electrode. The capacity of the negative electrode was adjusted to 1600 mAh. At one end of the negative electrode along its longitudinal direction, the core material was exposed as a core material-exposed portion.

### (v) Fabrication of Alkaline Storage Battery

Nickel-metal hydride storage batteries as illustrated in FIG. 2 were fabricated using the positive electrodes obtained in (iii) and the negative electrode obtained in (iv).

First, a positive electrode 2 and a negative electrode 1 were stacked with a separator 3 interposed therebetween, and they were spirally wound together, to form an electrode group. The separator 3 used here was made of sulfonated polypropylene.

A positive electrode current collector 9 was welded to the core-material exposed portion of the positive electrode 2, and a sealing plate 7 and the positive electrode current collector 9 were electrically connected to each other via a positive electrode lead. The electrode group was placed in a bottom-closed cylindrical battery case 4, and the outermost layer of the negative electrode 3 was brought into contact with the inner wall of the battery case 4, thereby to electrically connect them to each other.

The side wall near the opening of the battery case 4 was circumferentially recessed into a groove, and 2.0 cm³ of alkaline electrolyte was injected into the battery case 4. The alkaline electrolyte used here was an aqueous 7.0 mol/dm³ sodium hydroxide solution.

Next, the sealing plate 7 including a safety valve 6 and serving as a positive terminal was placed at the opening of the battery case 4, with an insulating gasket 8 interposed therebetween. The opening end of the battery case 4 was crimped onto the gasket 8, to close the battery case 4. AA-size sealed nickel-metal hydride storage batteries having a theoretical capacity of 1000 mAh in which the battery capacity was limited by the positive electrode were thus fabricated. After activated by charging and discharging (temperature: 20° C., conditions of charging: for 16 hours at 100 mA, conditions of discharging: for 5 hours at 200 mA), the nickel-metal hydride storage batteries were evaluated for various characteristics.

### (vi) Evaluation of Charge Characteristics at High Temperatures

The nickel-metal hydride storage batteries obtained in (v) were subjected to a charge/discharge test as below, to determine a utilization rate of a nickel oxide as a positive electrode active material (positive electrode utilization rate), as an indicator of the charge characteristics.

The nickel-metal hydride storage batteries were charged at an ambient temperature of 20° C. for 16 hours at a charge rate of 0.1 It, then left to stand for 3 hours at an ambient temperature of 25° C., and after that, discharged at an ambient temperature of 20° C. at a discharge rate of 0.2 It until the battery voltage dropped to 1.0 V. Such charge-discharge was repeated two cycles in total, and a discharge capacity at the 2^{nd} cycle was determined. The determined discharge capacity was substituted into the following equation to calculate a positive electrode utilization rate.

Positive electrode utilization rate (%)=Discharge capacity (mAh)/1000 (mAh)×100

The positive electrode utilization rates at 45° C. and 60° C. were determined in the same manner as above, except that the ambient temperature during charge was changed to 45° C. or 60° C.

### (vii) Evaluation of Storage Characteristics

The nickel-metal hydride storage batteries obtained in (v) were charged at 20° C. for 16 hours at a charge rate of 0.1 It. The charged nickel-metal hydride storage batteries were stored at an ambient temperature of 45° C. for 1 month or for 6 months. The nickel-metal hydride storage batteries before and after the storage were discharged at 20° C. at a discharge rate of 0.2 It until the battery voltage dropped to 1.0 V, to determine discharge capacities (mAh).

The determined discharge capacities were substituted into the following equation to calculate a capacity retention rate of each nickel-metal hydride storage battery after storage.

Capacity retention rate (%)=(Discharge capacity after storage) (mAh)/(Discharge capacity before storage) (mAh)×100

The positive electrode utilization rate and the capacity retention rate in each nickel-metal hydride storage battery are shown in Table 1, along with the features of the nickel oxide included therein.

TABLE 1

| | | | | | | | Positive electrode | | | Capacity retention | |
|---|---|---|---|---|---|---|---|---|---|---|---|
| | Nickel oxide | | | | | | utilization rate (%) | | | rate (%) | |
| | I₀₀₁ | I₁₀₁ | I₀₀₁/I₁₀₁ | FWHM₀₀₁ | FWHM₁₀₁ | FWHM₀₀₁/FWHM₁₀₁ | 20° C. | 45° C. | 60° C. | after 1M | after 6M |
| A1 | 13800 | 6000 | 2.30 | 0.450 | 0.900 | 0.50 | 94.0 | 90.0 | 85.0 | 75.0 | 50.0 |
| A2 | 13200 | | 2.20 | | | | 94.5 | 89.8 | 84.5 | 74.8 | 49.9 |
| A3 | 12600 | | 2.10 | | | | 94.3 | 90.2 | 85.2 | 74.7 | 49.6 |
| A4 | 12000 | | 2.00 | | | | 93.9 | 90.0 | 84.8 | 75.2 | 50.2 |
| A5 | 11400 | | 1.90 | | | | 92.0 | 88.0 | 82.0 | 73.0 | 47.5 |
| A6 | 13800 | | 2.30 | 0.495 | | 0.55 | 93.8 | 90.1 | 85.3 | 75.2 | 50.3 |
| A7 | 13200 | | 2.20 | | | | 94.5 | 91.1 | 88.0 | 76.5 | 55.0 |
| A8 | 12600 | | 2.10 | | | | 94.6 | 91.4 | 88.2 | 76.8 | 55.3 |
| A9 | 12000 | | 2.00 | | | | 94.4 | 91.5 | 88.3 | 77.0 | 55.5 |
| A10 | 11400 | | 1.90 | | | | 92.2 | 87.8 | 82.5 | 73.1 | 47.0 |
| A11 | 13800 | | 2.30 | 0.540 | | 0.60 | 93.8 | 90.2 | 85.0 | 74.8 | 55.2 |
| A12 | 13200 | | 2.20 | | | | 94.4 | 91.5 | 87.8 | 77.1 | 58.1 |
| A13 | 12600 | | 2.10 | | | | 94.3 | 91.3 | 87.5 | 76.9 | 58.0 |
| A14 | 12000 | | 2.00 | | | | 94.5 | 91.5 | 88.0 | 76.8 | 57.9 |
| A15 | 11400 | | 1.90 | | | | 92.0 | 88.0 | 82.0 | 73.2 | 47.4 |
| A16 | 13800 | | 2.30 | 0.585 | | 0.65 | 91.9 | 87.5 | 83.0 | 73.4 | 47.7 |
| A17 | 13200 | | 2.20 | | | | 91.7 | 88.0 | 82.5 | 73.0 | 47.8 |
| A18 | 12600 | | 2.00 | | | | 92.0 | 88.2 | 82.3 | 72.8 | 47.2 |
| A19 | 12000 | | 2.00 | | | | 92.2 | 87.7 | 83.2 | 72.9 | 47.0 |
| A20 | 11400 | | 1.90 | | | | 92.0 | 88.0 | 82.5 | 73.0 | 46.7 |

As shown in Table 1, in the nickel-metal hydride storage batteries including the nickel oxides A5, A10, A15 and A20 having a peak intensity ratio I₀₀₁/I₁₀₁ of less than 2, the positive electrode utilization rates were low, and in particular, the positive electrode utilization rates when charged at 60° C. were significantly low. In these batteries, the capacity retention rates after storage were also low, and in particular, the capacity retention rates after storage for 6 months were significantly low.

In contrast, in the nickel-metal hydride storage batteries including the nickel oxides A1 to A4, A6 to A9 and A11 to A14 having a peak intensity ratio I₀₀₁/I₁₀₁ of 2 or more, high positive electrode utilization rates and high capacity retention rates were obtained. The positive electrode utilization rates when charged at 60° C. and the capacity retention rates after storage for 6 months were also significantly higher than those including the nickel oxides A5, A10 and A15. This indicates that using the above nickel oxides can improve the charging efficiency at high temperatures, and suppress the self-discharge.

Even though the peak intensity ratio I₀₀₁/I₁₀₁ was 2 or more, when the full width at half maximum ratio FWHM₀₀₁/FWHM₁₀₁ was more than 0.6 as in the nickel oxides A16 to A19, the positive electrode utilization rates and the capacity retention rates were both lower than those when the full width at half maximum ratio FWHM₀₀₁/FWHM₁₀₁ was 0.6 or less.

Although nickel oxide particles with a cobalt oxide-containing conductive layer formed on their surfaces were used as the positive electrode active material in Example 1, a nickel oxide without such a conductive layer can be used with similar or analogous effects to the above.

### Example 2

Nickel oxide particles were prepared in the same manner as in Example 1, except for using, in (i) Production of nickel oxide, an aqueous nickel sulfate solution in which cobalt sulfate was added and dissolved such that 1.5 parts by mass of cobalt was included, relative to 98.5 parts by mass of nickel. Nickel oxides B1 to B20 including a conductive layer of cobalt oxide formed on the particle surfaces were produced in the same manner as in Example 1, except for using the prepared nickel oxide particles.

Nickel-metal hydride storage batteries were fabricated in the same manner as in Example 1, except for using the nickel oxides B1 to B20 as the positive electrode active material. The fabricated nickel-metal hydride storage batteries or the nickel oxides B1 to 320 were subjected to the same evaluation as in Example 1.

### Example 3

Nickel oxide particles were prepared in the same manner as in Example 2, except for using zinc sulfate, in place of the cobalt sulfate. Nickel oxides C1 to C20 including a conductive layer of cobalt oxide formed on the particle surfaces were produced using the prepared nickel oxide particles.

Nickel-metal hydride storage batteries were fabricated in the same manner as in Example 1, except for using the nickel oxides C1 to C20 as the positive electrode active material. The fabricated nickel-metal hydride storage batteries or the nickel oxides C1 to C20 were subjected to the same evaluation as in Example 1.

### Example 4

Nickel oxide particles were prepared in the same manner as in Example 2, except for using cobalt sulfate and zinc sulfate in the same mass ratio, in place of the cobalt sulfate. Nickel oxides D1 to D20 including a conductive layer of cobalt oxide formed on the particle surfaces were produced using the prepared nickel oxide particles.

Nickel-metal hydride storage batteries were fabricated in the same manner as in Example 1, except for using the nickel oxides D1 to D20 as the positive electrode active material. The fabricated nickel-metal hydride storage batteries or the nickel oxides D1 to D20 were subjected to the same evaluation as in Example 1.

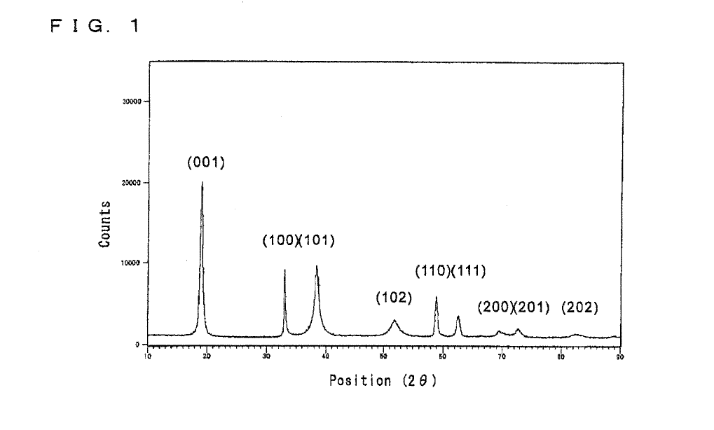

A powder X-ray 2θ/θ diffraction spectrum using CuKα radiation of the nickel oxide D3 measured with an X-ray diffractometer (X'PertPRO available from PANalytical B.V.) under the same conditions as in Examples is shown in FIG. 1.

The results of Examples 2 to 4 are shown in Tables 2 to 4.

TABLE 2

| | | | | | | | | Positive electrode | | | Capacity retention | |
|---|---|---|---|---|---|---|---|---|---|---|---|---|
| | Nickel oxide | | | | | | Metal | utilization rate (%) | | | rate (%) | |
| | I₀₀₁ | I₁₀₁ | I₀₀₁/I₁₀₁ | FWHM₀₀₁ | FWHM₁₀₁ | FWHM₀₀₁/FWHM₁₀₁ | element | 20° C. | 45° C. | 60° C. | after 1M | after 6M |
| B1 | 13800 | 6000 | 2.30 | 0.450 | 0.900 | 0.50 | Co | 96.2 | 92.2 | 87.7 | 76.5 | 55.0 |
| B2 | 13200 | | 2.20 | | | | | 96.3 | 92.1 | 87.4 | 77.0 | 55.5 |
| B3 | 12600 | | 2.10 | | | | | 96.1 | 92.2 | 87.3 | 76.7 | 54.8 |
| B4 | 12000 | | 2.00 | | | | | 95.9 | 92.2 | 87.4 | 76.4 | 55.0 |
| B5 | 11400 | | 1.90 | | | | | 96.3 | 91.8 | 85.3 | 75.0 | 48.0 |
| B6 | 13800 | | 2.30 | 0.495 | | 0.55 | | 96.2 | 92.3 | 87.5 | 77.0 | 55.0 |
| B7 | 13200 | | 2.20 | | | | | 95.8 | 92.6 | 88.2 | 77.5 | 58.1 |
| B8 | 12600 | | 2.10 | | | | | 95.7 | 92.8 | 88.2 | 77.7 | 57.5 |
| B9 | 12000 | | 2.00 | | | | | 96.3 | 92.7 | 88.3 | 78.0 | 58.0 |
| B10 | 11400 | | 1.90 | | | | | 96.2 | 91.7 | 85.4 | 74.8 | 47.5 |
| B11 | 13800 | | 2.30 | 0.540 | | 0.60 | | 96.1 | 92.2 | 87.5 | 76.5 | 55.2 |
| B12 | 13200 | | 2.20 | | | | | 96.2 | 92.6 | 88.5 | 78.2 | 58.1 |
| B13 | 12600 | | 2.10 | | | | | 96.1 | 92.5 | 88.2 | 78.0 | 58.0 |
| B14 | 12000 | | 2.00 | | | | | 96.2 | 92.5 | 88.3 | 77.8 | 57.9 |
| B15 | 11400 | | 1.90 | | | | | 96.0 | 91.8 | 85.2 | 75.2 | 48.2 |
| B16 | 13800 | | 2.30 | 0.585 | | 0.65 | | 96.2 | 91.7 | 85.2 | 75.1 | 48.0 |
| B17 | 13200 | | 2.20 | | | | | 96.3 | 91.6 | 84.9 | 74.8 | 47.8 |
| B18 | 12600 | | 2.10 | | | | | 96.2 | 91.5 | 84.9 | 74.8 | 47.4 |
| B19 | 12000 | | 2.00 | | | | | 95.9 | 91.6 | 85.2 | 75.0 | 47.5 |
| B20 | 11400 | | 1.90 | | | | | 96.1 | 91.7 | 85.1 | 74.9 | 47.9 |

TABLE 3

| | | | | | | | | Positive electrode | | | Capacity retention | |
|---|---|---|---|---|---|---|---|---|---|---|---|---|
| | Nickel oxide | | | | | | Metal | utilization rate (%) | | | rate (%) | |
| | I₀₀₁ | I₁₀₁ | I₀₀₁/I₁₀₁ | FWHM₀₀₁ | FWHM₁₀₁ | FWHM₀₀₁/FWHM₁₀₁ | element | 20° C. | 45° C. | 60° C. | after 1M | after 6M |
| C1 | 13800 | 6000 | 2.30 | 0.450 | 0.900 | 0.50 | Zn | 95.8 | 91.8 | 87.6 | 77.0 | 56.0 |
| C2 | 13200 | | 2.20 | | | | | 96.1 | 91.9 | 87.3 | 77.1 | 55.5 |
| C3 | 12600 | | 2.10 | | | | | 96.0 | 92.2 | 87.1 | 76.8 | 55.0 |
| C4 | 12000 | | 2.00 | | | | | 95.7 | 92.0 | 87.2 | 76.8 | 55.4 |
| C5 | 11400 | | 1.90 | | | | | 96.1 | 91.6 | 85.1 | 74.8 | 48.1 |
| C6 | 13800 | | 2.30 | 0.495 | | 0.55 | | 96.0 | 92.1 | 87.2 | 77.1 | 54.8 |
| C7 | 13200 | | 2.20 | | | | | 95.8 | 92.4 | 88.1 | 78.0 | 58.0 |
| C8 | 12600 | | 2.10 | | | | | 95.6 | 92.5 | 88.0 | 78.1 | 57.9 |
| C9 | 12000 | | 2.00 | | | | | 96.0 | 92.5 | 88.2 | 78.3 | 58.3 |
| C10 | 11400 | | 1.90 | | | | | 96.0 | 91.5 | 85.3 | 74.8 | 47.8 |
| C11 | 13800 | | 2.30 | 0.540 | | 0.60 | | 96.1 | 92.0 | 87.3 | 76.5 | 55.4 |
| C12 | 13200 | | 2.20 | | | | | 96.1 | 92.4 | 88.2 | 78.3 | 58.4 |
| C13 | 12600 | | 2.10 | | | | | 96.2 | 92.2 | 88.1 | 77.7 | 58.2 |
| C14 | 12000 | | 2.00 | | | | | 96.0 | 92.3 | 88.0 | 77.9 | 57.9 |
| C15 | 11400 | | 1.90 | | | | | 95.7 | 91.6 | 85.1 | 74.9 | 48.0 |
| C16 | 13800 | | 2.30 | 0.585 | | 0.65 | | 95.8 | 91.4 | 85.2 | 75.0 | 47.8 |
| C17 | 13200 | | 2.20 | | | | | 96.0 | 91.4 | 84.9 | 75.5 | 48.0 |
| C18 | 12600 | | 2.10 | | | | | 96.2 | 91.3 | 84.8 | 75.2 | 48.1 |
| C19 | 12000 | | 2.00 | | | | | 95.7 | 91.5 | 85.1 | 74.9 | 47.7 |
| C20 | 11400 | | 1.90 | | | | | 95.9 | 91.6 | 85.3 | 75.2 | 47.6 |

TABLE 4

| | | | | | | | | Positive electrode | | | Capacity retention | |
|---|---|---|---|---|---|---|---|---|---|---|---|---|
| | Nickel oxide | | | | | | Metal | utilization rate (%) | | | rate (%) | |
| | I₀₀₁ | I₁₀₁ | I₀₀₁/I₁₀₁ | FWHM₀₀₁ | FWHM₁₀₁ | FWHM₀₀₁/FWHM₁₀₁ | element | 20° C. | 45° C. | 60° C. | after 1M | after 6M |
| D1 | 13800 | 6000 | 2.30 | 0.450 | 0.900 | 0.50 | Co + Zn | 96.3 | 92.4 | 87.8 | 76.5 | 55.0 |
| D2 | 13200 | | 2.20 | | | | | 96.4 | 92.3 | 87.5 | 77.0 | 55.4 |
| D3 | 12600 | | 2.10 | | | | | 96.2 | 92.3 | 87.2 | 76.8 | 56.0 |
| D4 | 12000 | | 2.00 | | | | | 95.8 | 92.2 | 87.3 | 77.2 | 55.4 |
| D5 | 11400 | | 1.90 | | | | | 96.3 | 91.9 | 85.4 | 75.0 | 48.0 |
| D6 | 13800 | | 2.30 | 0.495 | | 0.55 | | 96.3 | 92.2 | 87.6 | 77.3 | 55.0 |
| D7 | 13200 | | 2.20 | | | | | 95.9 | 92.7 | 88.4 | 78.2 | 58.0 |
| D8 | 12600 | | 2.10 | | | | | 95.9 | 92.7 | 88.3 | 78.3 | 58.2 |
| D9 | 12000 | | 2.00 | | | | | 96.5 | 92.9 | 88.6 | 78.2 | 58.4 |
| D10 | 11400 | | 1.90 | | | | | 96.4 | 91.9 | 85.5 | 75.0 | 47.9 |
| D11 | 13800 | | 2.30 | 0.540 | | 0.60 | | 96.2 | 92.3 | 87.6 | 76.5 | 55.0 |
| D12 | 13200 | | 2.20 | | | | | 96.4 | 92.7 | 88.4 | 78.5 | 59.0 |
| D13 | 12600 | | 2.10 | | | | | 96.5 | 92.6 | 88.3 | 77.9 | 58.4 |
| D14 | 12000 | | 2.00 | | | | | 96.4 | 92.4 | 88.5 | 78.0 | 57.8 |
| D15 | 11400 | | 1.90 | | | | | 96.3 | 91.9 | 85.3 | 75.0 | 47.8 |
| D16 | 13800 | | 2.30 | 0.585 | | 0.65 | | 96.4 | 91.7 | 85.3 | 74.9 | 48.0 |
| D17 | 13200 | | 2.20 | | | | | 96.3 | 91.8 | 84.7 | 74.5 | 48.0 |
| D18 | 12600 | | 2.10 | | | | | 96.3 | 91.7 | 84.8 | 75.2 | 48.3 |
| D19 | 12000 | | 2.00 | | | | | 95.8 | 91.7 | 85.3 | 74.9 | 47.7 |
| D20 | 11400 | | 1.90 | | | | | 96.2 | 91.9 | 85.0 | 75.0 | 47.5 |

As shown in Tables 2 to 4, in the nickel-metal hydride storage batteries including the nickel oxides having a peak intensity ratio I₀₀₁/I₁₀₁ of less than 2, the positive electrode utilization rates were low, and in particular, the positive electrode utilization rates when charged at 60° C. were significantly low. In these batteries, the capacity retention rates after storage were also low, and in particular, the capacity retention rates after storage for 6 months were significantly low.

In contrast, in the nickel-metal hydride storage batteries including the nickel oxides having a peak intensity ratio I₀₀₁/I₁₀₁ of 2 or more, high positive electrode utilization rates and high capacity retention rates were obtained. In particular, the positive electrode utilization rates when charged at 60° C. and the capacity retention rates after storage for 6 months were significantly increased. Even as compared with the results of Table 1 of nickel oxides with neither cobalt nor zinc incorporated into their crystals, the positive electrode utilization rates at 60° C. and the capacity retention rates after storage for 6 months were high.

Even though the peak intensity ratio I₀₀₁/I₁₀₁ was 2 or more, when the full width at half maximum ratio FWHM₀₀₁/FWHM₁₀₁ was more than 0.6, the positive electrode utilization rates and the capacity retention rates were both lower than those when the full width at half maximum ratio FWHM₀₀₁/FWHM₁₀₁ was 0.6 or less.

As shown in Tables 2 to 4, using the nickel oxides B7 to B9, C7 to C9, D7 to D9, and B12 to B14, C12 to C14, and D12 to D14 remarkably improved the positive electrode utilization rates when charged at 60° C. and the capacity retention rates after storage. The results show that a preferable peak intensity ratio I₀₀₁/I₁₀₁ is less than 2.3, and more preferably, 2.2 or less. A preferable full width at half maximum ratio FWHM₀₀₁/FWHM₁₀₁ is more than 0.5, and more preferably, 0.55 or more.

Although nickel oxides with cobalt and/or zinc incorporated in their crystal structures were used as the positive electrode active material in these examples, similar or analogous effects were obtained when cadmium, magnesium or the like were incorporated in place of cobalt and zinc. Furthermore, although the positive electrode active materials used in these examples were of nickel oxide particles with a cobalt oxide-containing conductive layer formed on the particle surfaces, similar or analogous effects were obtained when nickel oxide particles without such a conductive layer were used.

### Examples 5 to 8

Positive electrode pastes were prepared in the same manner in Example 2, except that metal compounds as shown in Tables 5 to 8 were used in combination with the nickel oxides B8, B11, D8, or till serving as the positive electrode active material, in an amount as shown in Tables 5 to 8, relative to 100 parts by mass of nickel oxide. Positive electrodes were produced using the prepared positive electrode pastes. Nickel-metal hydride storage batteries were fabricated in the same manner as in Example 1, except for using the produced positive electrodes. The fabricated nickel-metal hydride storage batteries were subjected to the same evaluation as in Example 1.

The results of Examples 5 to 8 are respectively shown in Tables 5 to 8, along with the type and amount of the metal compounds used therein.

TABLE 5

| | | | | | | | | Capacity | |
|---|---|---|---|---|---|---|---|---|---|
| | | | | | | | | retention | |
| | Metal compound | | | | Positive electrode | | | rate (%) | |
| | (parts by mass) | | | | utilization rate (%) | | | after | after |
| Ex. 5 | Ca(OH)₂ | TiO₂ | ZnO | Yb₂O₃ | 20° C. | 45° C. | 60° C. | 1M | 6M |
| B8 | | | | | 95.7 | 92.8 | 88.2 | 77.7 | 57.5 |
| B8-C | 1.00 | | | | 96.0 | 93.2 | 89.5 | 79.5 | 60.0 |
| B8-T | | 1.00 | | | 95.9 | 93.3 | 89.8 | 79.8 | 59.6 |
| B8-Z | | | 1.00 | | 96.1 | 93.3 | 89.9 | 80.0 | 60.2 |
| B8-Y | | | | 1.00 | 96.2 | 93.4 | 90.0 | 80.1 | 60.1 |
| B8-CT | 0.50 | 0.50 | | | 96.2 | 93.3 | 90.1 | 79.9 | 60.0 |
| B8-CZ | 0.50 | | 0.50 | | 96.3 | 93.5 | 89.6 | 80.0 | 60.3 |
| B8-CY | 0.50 | | | 0.50 | 96.1 | 93.4 | 89.7 | 80.5 | 60.3 |
| B8-TZ | | 0.50 | 0.50 | | 96.1 | 93.2 | 89.9 | 80.2 | 60.5 |
| B8-TY | | 0.50 | | 0.50 | 96.0 | 93.4 | 90.0 | 80.4 | 60.3 |
| B8-ZY | | | 0.50 | 0.50 | 95.9 | 93.4 | 90.2 | 80.0 | 60.0 |
| B8-CTZ | 0.33 | 0.33 | 0.33 | | 96.0 | 93.2 | 89.6 | 79.9 | 59.9 |
| B8-CTY | 0.33 | 0.33 | | 0.33 | 96.1 | 93.3 | 89.7 | 79.5 | 59.7 |
| B8-CZY | 0.33 | | 0.33 | 0.33 | 96.2 | 93.4 | 89.9 | 79.7 | 60.0 |
| B8-TZY | | 0.33 | 0.33 | 0.33 | 96.0 | 93.2 | 90.0 | 79.9 | 60.1 |
| B8-CTZY | 0.25 | 0.25 | 0.25 | 0.25 | 96.2 | 93.3 | 90.1 | 80.0 | 60.5 |

TABLE 6

| | | | | | | | | Capacity | |
|---|---|---|---|---|---|---|---|---|---|
| | | | | | | | | retention | |
| | Metal compound | | | | Positive electrode | | | rate (%) | |
| | (parts by mass) | | | | utilization rate (%) | | | after | after |
| Ex. 6 | Ca(OH)₂ | TiO₂ | ZnO | Yb₂O₃ | 20° C. | 45° C. | 60° C. | 1M | 6M |
| B11 | | | | | 96.1 | 92.2 | 87.5 | 76.5 | 55.2 |
| B11-C | 1.00 | | | | 96.0 | 92.5 | 88.0 | 77.8 | 58.0 |
| B11-T | | 1.00 | | | 95.9 | 92.4 | 88.1 | 77.9 | 58.1 |
| B11-Z | | | 1.00 | | 95.8 | 92.5 | 88.3 | 78.0 | 58.0 |
| B11-Y | | | | 1.00 | 96.1 | 92.3 | 88.2 | 77.9 | 58.0 |
| B11-CT | 0.50 | 0.50 | | | 96.0 | 92.6 | 88.1 | 78.2 | 58.4 |
| B11-CZ | 0.50 | | 0.50 | | 96.2 | 92.5 | 88.0 | 78.0 | 58.2 |
| B11-CY | 0.50 | | | 0.50 | 95.7 | 92.4 | 88.2 | 78.1 | 58.0 |
| B11-TZ | | 0.50 | 0.50 | | 95.9 | 92.3 | 88.3 | 78.4 | 57.9 |
| B11-TY | | 0.50 | | 0.50 | 95.8 | 92.3 | 88.2 | 78.2 | 58.0 |
| B11-ZY | | | 0.50 | 0.50 | 95.9 | 92.3 | 88.1 | 78.1 | 58.3 |
| B11-CTZ | 0.33 | 0.33 | 0.33 | | 96.0 | 92.4 | 88.1 | 78.0 | 57.9 |
| B11-CTY | 0.33 | 0.33 | | 0.33 | 96.1 | 92.6 | 88.0 | 77.9 | 58.0 |
| B11-CZY | 0.33 | | 0.33 | 0.33 | 96.1 | 92.4 | 88.4 | 77.8 | 57.7 |
| B11-TZY | | 0.33 | 0.33 | 0.33 | 96.2 | 92.4 | 88.3 | 78.0 | 57.8 |
| B11-CTZY | 0.25 | 0.25 | 0.25 | 0.25 | 95.9 | 92.3 | 88.2 | 78.3 | 58.0 |

TABLE 7

| | | | | | | | | Capacity | |
|---|---|---|---|---|---|---|---|---|---|
| | | | | | | | | retention | |
| | Metal compound | | | | Positive electrode | | | rate (%) | |
| | (parts by mass) | | | | utilization rate (%) | | | after | after |
| Ex. 7 | Ca(OH)₂ | TiO₂ | ZnO | Yb₂O₃ | 20° C. | 45° C. | 60° C. | 1M | 6M |
| D8 | | | | | 95.9 | 92.7 | 88.3 | 78.3 | 58.2 |
| D8-C | 1.00 | | | | 96.2 | 93.3 | 89.9 | 79.5 | 60.0 |
| D8-T | | 1.00 | | | 95.8 | 93.5 | 89.7 | 79.8 | 59.6 |
| D8-Z | | | 1.00 | | 96.3 | 93.5 | 89.8 | 80.0 | 60.2 |
| D8-Y | | | | 1.00 | 96.3 | 93.3 | 90.2 | 80.1 | 60.1 |
| D8-CT | 0.50 | 0.50 | | | 96.1 | 93.4 | 90.0 | 80.5 | 60.3 |
| D8-CZ | 0.50 | | 0.50 | | 96.2 | 93.3 | 89.7 | 80.0 | 60.3 |
| D8-CY | 0.50 | | | 0.50 | 96.4 | 93.6 | 89.8 | 79.9 | 60.0 |
| D8-TZ | | 0.50 | 0.50 | | 96.4 | 93.3 | 89.7 | 80.0 | 60.0 |
| D8-TY | | 0.50 | | 0.50 | 96.3 | 93.2 | 90.1 | 80.2 | 60.5 |
| D8-ZY | | | 0.50 | 0.50 | 95.9 | 93.5 | 90.0 | 80.4 | 60.3 |
| D8-CTZ | 0.33 | 0.33 | 0.33 | | 96.2 | 93.3 | 89.7 | 80.0 | 60.5 |
| D8-CTY | 0.33 | 0.33 | | 0.33 | 96.0 | 93.2 | 89.9 | 79.9 | 59.9 |
| D8-CZY | 0.33 | | 0.33 | 0.33 | 96.1 | 93.3 | 89.6 | 79.9 | 60.1 |
| D8-TZY | | 0.33 | 0.33 | 0.33 | 96.3 | 93.4 | 90.3 | 79.7 | 60.0 |
| D8-CTZY | 0.25 | 0.25 | 0.25 | 0.25 | 96.4 | 93.4 | 90.3 | 79.5 | 59.7 |

TABLE 8

| | | | | | | | | Capacity | |
|---|---|---|---|---|---|---|---|---|---|
| | | | | | | | | retention | |
| | Metal compound | | | | Positive electrode | | | rate (%) | |
| | (parts by mass) | | | | utilization rate (%) | | | after | after |
| Ex. 8 | Ca(OH)₂ | TiO₂ | ZnO | Yb₂O₃ | 20° C. | 45° C. | 60° C. | 1M | 6M |
| D11 | | | | | 96.2 | 92.3 | 87.6 | 76.5 | 55.0 |
| D11-C | 1.00 | | | | 96.2 | 92.4 | 88.2 | 77.8 | 58.0 |
| D11-T | | 1.00 | | | 95.8 | 92.6 | 88.2 | 77.9 | 58.1 |
| D11-Z | | | 1.00 | | 95.9 | 92.6 | 88.4 | 77.9 | 58.0 |
| D11-Y | | | | 1.00 | 96.2 | 92.4 | 88.1 | 78.0 | 58.0 |
| D11-CT | 0.50 | 0.50 | | | 96.3 | 92.4 | 88.2 | 78.0 | 58.2 |
| D11-CZ | 0.50 | | 0.50 | | 96.1 | 92.4 | 88.4 | 78.1 | 58.0 |
| D11-CY | 0.50 | | | 0.50 | 95.9 | 92.5 | 88.3 | 78.4 | 57.9 |
| D11-TZ | | 0.50 | 0.50 | | 95.8 | 92.5 | 88.4 | 78.3 | 58.0 |
| D11-TY | | 0.50 | | 0.50 | 95.9 | 92.4 | 88.2 | 78.2 | 58.4 |
| D11-ZY | | | 0.50 | 0.50 | 95.7 | 92.6 | 88.0 | 78.2 | 58.0 |
| D11-CTZ | 0.33 | 0.33 | 0.33 | | 96.2 | 92.4 | 88.4 | 78.1 | 58.3 |
| D11-CTY | 0.33 | 0.33 | | 0.33 | 96.1 | 92.4 | 88.2 | 78.0 | 57.9 |
| D11-CZY | 0.33 | | 0.33 | 0.33 | 96.3 | 92.5 | 88.3 | 78.0 | 57.8 |
| D11-TZY | | 0.33 | 0.33 | 0.33 | 96.3 | 92.3 | 88.2 | 77.9 | 58.0 |
| D11-CTZY | 0.25 | 0.25 | 0.25 | 0.25 | 95.8 | 92.6 | 88.4 | 77.8 | 57.7 |

As shown in Tables 5 to 8, when the positive electrode further includes a metal compound in addition to the nickel oxide, the positive electrode utilization rates when charged at 45° C. and 60° C. and the capacity retention rates after storage were improved as compared with when not including a metal compound. In particular, the positive electrode utilization rates when charged at 60° C. and the capacity retention rates after storage for 6 months were remarkably improved by the addition of a metal compound. The foregoing shows that the addition of a metal compound can improve the charging efficiency and suppress the self-discharge.

Although the metal compound added to the positive electrode paste was Ca(OH)₂, TiO₂, ZnO, and/or Yb₂O₃ in the above examples, similar or analogous effects were obtained when other metal compounds including beryllium, calcium, barium, scandium, yttrium, erbium, thulium, ytterbium, lutetium, titanium, zirconium, vanadium, niobium, zinc, indium and/or antimony were used.

In particular, favorable effects were obtained when BeO, CaF₂, Ba (OH)₂, SC₂O₃, Y₂O₃, Er₂O₃, Tm₂O₃, Lu₂O₃, ZrO₂, V₂O₅, Nb₂O₅, In₂O₃, and/or Sb₂O₃ were used.

### Example 9

Alkaline electrolytes were prepared by dissolving sodium hydroxide or potassium hydroxide as an electrolytic solute in water at a concentration as shown in Table 9. Nickel-metal hydride storage batteries were fabricated in the same manner as in Example 2, except for using the prepared alkaline electrolytes and the nickel oxide B8 as the positive electrode active material. The fabricated nickel-metal hydride storage batteries were subjected to the same evaluation as in Example 1 and the following evaluation.

(i) Evaluation of Discharge Characteristics

The nickel-metal hydride storage batteries were charged at an ambient temperature of 20° C. for 16 hours at a charge rate of 0.1 It, then discharged at an ambient temperature of 20° C. at a discharge rate of 0.2 It or 1.0 It until the battery voltage dropped to 1.0 V, to measure an average discharge voltage.

(ii) Evaluation of Cycle Life

The nickel-metal hydride storage batteries were charged at an ambient temperature of 20° C. for 16 hours at a charge rate of 0.1 It, then discharged at an ambient temperature of 20° C. at a discharge rate of 0.2 It or 1.0 It until the battery voltage dropped to 1.0 V. Such charge-discharge was repeated, and the number of charge-discharge cycles repeated until the discharge capacity reached 60% of the initial battery capacity was counted as an indicator of the cycle life.

TABLE 9

| | | | | | | | Capacity | | | | | | |
|---|---|---|---|---|---|---|---|---|---|---|---|---|---|
| | Electrolyte | | | | | | retention | | Discharge | | | | |
| | concentration | | | Positive electrode | | | rate (%) | | 0.2 It | | 1.0 It | | Number |
| | (mol/dm³) | | | utilization rate (%) | | | after | after | Voltage | Capacity | Voltage | Capacity | of |
| Ex. 9 | NaOH | KOH | Total | 20° C. | 45° C | 60° C. | 1M | 6M | (V) | (mAh) | (V) | (mAh) | cycles |
| B8a | 3.0 | 0.0 | 3.0 | 93.5 | 89.5 | 84.0 | 75.3 | 54.0 | 1.267 | 935 | 1.203 | 900 | 2000 |
| B8b | 4.0 | 0.0 | 4.0 | 95.0 | 92.0 | 87.8 | 77.5 | 57.3 | 1.265 | 950 | 1.200 | 910 | 1900 |
| B8c (B8) | 7.0 | 0.0 | 7.0 | 95.7 | 92.8 | 88.2 | 77.7 | 57.5 | 1.260 | 957 | 1.195 | 925 | 1850 |
| B8d | 10.0 | 0.0 | 10.0 | 96.3 | 93.5 | 89.5 | 78.0 | 58.0 | 1.255 | 963 | 1.190 | 930 | 1800 |
| B8e | 11.0 | 0.0 | 11.0 | 97.0 | 94.0 | 90.0 | 78.2 | 58.1 | 1.235 | 970 | 1.155 | 820 | 1500 |
| B8f | 3.0 | 9.0 | 12.0 | 92.5 | 89.0 | 85.0 | 75.1 | 53.4 | 1.268 | 925 | 1.205 | 889 | 1900 |
| B8g | 4.0 | 8.0 | 12.0 | 94.0 | 92.0 | 88.0 | 78.0 | 58.5 | 1.263 | 940 | 1.195 | 905 | 1850 |
| B8h | 10.0 | 2.0 | 12.0 | 95.5 | 93.0 | 89.0 | 78.5 | 59.0 | 1.254 | 955 | 1.191 | 915 | 1800 |
| B8i | 11.0 | 1.0 | 12.0 | 96.0 | 94.0 | 90.0 | 79.0 | 59.5 | 1.230 | 960 | 1.150 | 775 | 1600 |

As shown in Table 9, when sodium hydroxide only was used as an electrolytic solute and when sodium hydroxide and potassium hydroxide were used in combination, the positive electrode utilization rates were improved with increase in the sodium hydroxide concentration. Even at a high temperature of 60° C., the positive electrode utilization rates were improved. The results indicate that increasing the sodium hydroxide concentration can more effectively improve the charging efficiency at high temperatures.

Increasing the sodium hydroxide concentration, however, causes the discharge average voltage to drop, resulting in a shorter cycle life. Particularly when the sodium hydroxide concentration exceeded 10 mol/dm³, the discharge average voltage dropped to below 1.250 V at 0.2 It, and below 1.190 V at 1.0 It, and the discharge capacity was reduced at 1.0 It. Moreover, when the sodium hydroxide concentration exceeds 10 mol/dm³, the cycle life tends to be shorter. For such reasons, the sodium hydroxide concentration in the electrolyte is preferably 10 mol/dm³ or less.

Decreasing the sodium hydroxide concentration tends to improve the discharge characteristics and the cycle life, but lower the positive electrode utilization rate when charged at high temperatures and the capacity retention rate after storage. This may reduce the usefulness in practical use. Therefore, the sodium hydroxide concentration in the electrolyte is preferably 4 mol/dm³ or more.

Although an aqueous solution including sodium hydroxide or including sodium hydroxide and potassium hydroxide was used as the alkaline electrolyte in the above examples, similar or analogous effects were obtained when an aqueous solution including sodium hydroxide and lithium hydroxide, and an aqueous solution including sodium hydroxide, potassium hydroxide and lithium hydroxide were used.

Based on the foregoing results, it can be concluded that in nickel-metal hydride storage batteries, excellent effects can be obtained particularly in the following cases.

The positive electrode includes an electrically conductive support, and a mixture adhering to the support and including a positive electrode active material and a metal compound. The positive electrode active material includes a particle including a nickel oxide, and a conductive layer formed on the particle surfaces and including a cobalt oxide. The nickel oxide has a peak intensity ratio I₀₀₁/I₁₀₁ of 2 to 2.2, and a full width at half maximum ratio FWHM₀₀₁/FWHM₁₀₁ of 0.55 to 0.6. The metal compound includes at least one selected from the group consisting of calcium, ytterbium, titanium, and zinc. The alkaline electrolyte is an aqueous alkaline solution containing at least sodium hydroxide at a concentration of 4 to 10 mol/dm³.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

According to the positive electrode active material for alkaline storage batteries of the present invention, a high charging efficiency can be achieved even when charged at a wide range of temperatures including high temperatures. Moreover, the self-discharge can be effectively suppressed. The positive electrode active material of the present invention are therefore usefully applicable to alkaline storage batteries used as power source for various electronic devices, transportation equipment, electricity accumulators, and other applications. The alkaline storage battery of the present invention can be particularly suitably used as power source for electric cars, hybrid cars, and the like.

### REFERENCE SIGNS LIST

1 Negative electrode
2 Positive electrode
3 Separator
4 Battery case
6 Safety valve
7 Sealing plate
8 Insulating gasket
9 Positive electrode current collector

1. A positive electrode active material for alkaline storage batteries, comprising a nickel oxide,
the nickel oxide having a ratio I₀₀₁/I₁₀₁ of a peak intensity I₀₀₁ of (001) plane to a peak intensity I₁₀₁ of (101) plane being 2 or more, and a ratio FWHM₀₀₁/FWHM₁₀₁ of a full width at half maximum FWHM₀₀₁ of (001) plane to a full width at half maximum FWHM₁₀₁ of (101) plane being 0.6 or less, in a powder X-ray 2θ/θ diffraction pattern using CuKα radiation.

2. The positive electrode active material for alkaline storage batteries according to claim 1, wherein the ratio I₀₀₁/I₁₀₁ is 2 to 2.2, and the ratio FWHM₀₀₁/FWHM₁₀₁ is 0.55 to 0.6.

3. The positive electrode active material for alkaline storage batteries according to claim 1, wherein
the nickel oxide includes a first metal element incorporated in a crystal structure of the nickel oxide, and
the first metal element is at least one selected from the group consisting of magnesium, cobalt, cadmium, and zinc.

4. The positive electrode active material for alkaline storage batteries according to claim 1, comprising: a particle including the nickel oxide; and an electrically conductive layer formed on a surface of the particle,
the conductive layer including a cobalt oxide.

5. A positive electrode for alkaline storage batteries, comprising an electrically conductive support, and the positive electrode active material for alkaline storage batteries of claim 1, the positive electrode active material adhering to the support.

6. The positive electrode for alkaline storage batteries according to claim 5, including a mixture of the positive electrode active material for alkaline storage batteries and a metal compound, the mixture adhering to the support,
the metal compound including at least one second metal element selected from the group consisting of alkali earth metals, Periodic Table Group 3 metals, Group 4 metals, Group 5 metals, Group 12 metals, Group 13 metals, and Group 15 metals.

7. The positive electrode for alkaline storage batteries according to claim 6, wherein the second metal element included in the metal compound is at least one selected from the group consisting of beryllium, calcium, barium, scandium, yttrium, erbium, thulium, ytterbium, lutetium, titanium, zirconium, vanadium, niobium, zinc, indium, and antimony.

8. The positive electrode for alkaline storage batteries according to claim 6, wherein the second metal element included in the metal compound is at least one selected from the group consisting of alkali earth metals, lanthanoids, Periodic Table Group 4 metals, and Group 12 metals.

9. The positive electrode for alkaline storage batteries according to claim 6, wherein the metal compound is at least one selected from the group consisting of oxides, hydroxides, and fluorides, the oxides, the hydroxides, and the fluorides containing the second metal element.

10. An alkaline storage battery, comprising
a positive electrode, a negative electrode, a separator interposed between the positive electrode and the negative electrode, and an alkaline electrolyte,
the positive electrode is the positive electrode for alkaline storage batteries of claim 5.

11. The alkaline storage battery according to claim 10, being a nickel-metal hydride storage battery, wherein the negative electrode includes a hydrogen storage alloy powder capable of electrochemically absorbing and releasing hydrogen.

12. The alkaline storage battery according to claim 10, wherein the alkaline electrolyte is an aqueous alkaline solution containing at least sodium hydroxide at a concentration of 4 to 10 mol/dm³.

13. A nickel-metal hydride storage battery, comprising
a positive electrode, a negative electrode including a hydrogen storage alloy powder capable of electrochemically absorbing and releasing hydrogen, a separator interposed between the positive electrode and the negative electrode, and an alkaline electrolyte,
the positive electrode including an electrically conductive support, and a mixture of a positive electrode active material and a metal compound, the mixture adhering to the support,
the positive electrode active material including a particle including a nickel oxide, and an electrically conductive layer formed on a surface of the particle and including a cobalt oxide,
the nickel oxide including cobalt and zinc that are incorporated in a crystal structure of the nickel oxide, the nickel oxide having a ratio I₀₀₁/I₁₀₁ of a peak intensity I₀₀₁ of (001) plane to a peak intensity I₁₀₁ of (101) plane being 2 to 2.2, and a ratio FWHM₀₀₁/FWHM₁₀₁ of a full width at half maximum FWHM₀₀₁ of (001) plane to a full width at half maximum FWHM₁₀₁ of (101) plane being 0.55 to 0.6, in a powder X-ray 2θ/θ diffraction pattern using CuKα radiation,
the metal compound including at least one metal element selected from the group consisting of calcium, ytterbium, titanium, and zinc,
the alkaline electrolyte being an aqueous alkaline solution containing at least sodium hydroxide at a concentration of 4 to 10 mol/dm³.

14. The nickel-metal hydride storage battery according to claim 13, wherein the metal compound includes ytterbium, titanium, and zinc.
